(19) United States
(12) Patent Application Publication
(10) Pub. No.: US 2020/0207376 A1
(43) Pub. Date: Jul. 2, 2020

(54) POWER SYSTEM AND ASSOCIATED METHOD

(71) Applicant: FMS ADVISERS, Den Haag (NL)

(72) Inventor: Frank Matthias SCHUHHOLZ, The Hague (NL)

(21) Appl. No.: 16/647,066

(22) PCT Filed: Sep. 17, 2018
(86) PCT No.: PCT/NL2018/050611

§ 371 Date: Mar. 13, 2020

(30) Foreign Application Priority Data
Sep. 15, 2017 (NL) 2019561

(51) Int. Cl. B61C 3/02; B60L 50/40; B60L 50/53

(52) U.S. Cl. CPC B61C 3/02; B60L 2200/26; B60L 50/53; B60L 50/40

(57) ABSTRACT

An electrically-powered vehicle assembly for moving on partially electrified railway tracks, the vehicle assembly comprising: i. an electrically powered traction system; ii. a storage and autonomous electric power supply system comprising i. an accumulator unit comprising one or more electricity accumulators, and ii. a super capacitor unit comprising one or more super-capacitive assemblies; iii. a power supply device for supplying external power when available to the traction and the storage and supply system, and iv. a control and distribution system for distributing electric power between the traction system, the power supply device and the electric power storage and autonomous supply system according to the traction operation and availability of external power, wherein the at least one traction system, and the at least one storage and autonomous electric power supply system are spaced apart in separate vehicles connected by a standard electrical train bus bar (ETBB), and wherein at least part of the electrical power required for traction or (re) charging is distributed through the standard electrical train bus bar (ETBB).

### TECHNICAL FIELD

The present invention relates to a method and to a device for controlling the electrical power supply of an electric traction vehicle intended to operate in an external supply mode or in an autonomous supply mode depending on the presence or the absence of an external power supply infrastructure along the vehicle's trajectory. The invention relates in particular to the supply of electrical energy to rail vehicles, and to a power and a propulsion system for electric rail vehicles.

### BACKGROUND OF THE INVENTION

Most of the European countries offer very good railroad infrastructure, the majority if which are electrified. However, electrification of the non-grid served network represents a major investment, which in particular for tracks that are not frequently use may be considered as too expensive, as rail transport competes with road and shipping transport, and thus get sub-optimal volume streams that do normally not permit the required investment due to higher than necessary unit costs due to lack of economies of scale with regard to asset utilisation. Also, presently there is a shortage of adequate rolling stock, which cannot easily be replaced.

Direct Diesel engine drive are presently the standard propulsion vehicles for railway transport of goods on track trajectories with interrupted, or no electric grid connection available, as they can operate autonomously from grid electricity, thereby propelling rail cars for goods and/or passengers. Despite their widespread commercial use, such locomotives or otherwise rail vehicles have clear disadvantages. They produce air pollution, especially particulate soot suspected to cause a variety of illnesses; they are noisy, and their fuel sources are limited due to their dependence on fossil fuels.

In recent years, Diesel-electric locomotives have been developed, which run a Diesel engine as a stationary electric generator, producing electrical power for an electric propulsion system and auxiliary functionality.

While such engine-generator couplings may permit to run the Diesel engine often at a constant optimal operational window, the concept suffers from the high weight of the doubly functional propulsion system.

In comparison to diesel-powered vehicles, electric rail vehicles offer substantially better energy efficiency, lower emissions and lower operating costs. Electric locomotives are also usually quieter, more powerful, and more responsive and reliable than diesels. They have no local emissions, an important advantage in tunnels and urban areas. Some electric traction systems provide regenerative braking that turns the train's kinetic energy back into electricity and returns it to the supply system to be used by other trains or the general utility grid. Accordingly it would be desirable to operate all-electric rail vehicles even on non-electrified rail tracks, in particular in urban centres and industrial areas.

Independently from a direct or an indirect drive, combustion engines are complex, with many moving parts subject to wear, and require lubrication and lubrication and regular maintenance. Also, such engines are comparatively inefficient due to the inherent limitations of thermodynamic engines. Hence, it would be particularly helpful if Diesel-electric locomotives and trains could be converted to become emission-free, i.e. without producing soot particles, CO, CO₂ and NOₓ, or be replaced by emission-free vehicles.

The present invention relates to railway propulsion systems with no direct emissions, which can be used on grid-connected and off-grid connected railway lines.

### Summary

According to a first aspect there is provided an electrically-powered vehicle assembly for moving on partially electrified railway tracks, the vehicle assembly comprising: an electrically powered traction system; a) a storage and autonomous electric power supply system comprising i. an accumulator unit comprising one or more electricity accumulators, preferably but not limited to a lithium or lithium iron or polymer or solid state assembly, and ii. a super capacitor unit comprising one or more super-capacitive assemblies; b) a power supply device for supplying external power when available to the traction and the storage and supply system, and c) a control and distribution system, also referred to as the Intelligent Energy Management System (IEMS) herein, for distributing electric power between the traction system, the power supply device and the electric power storage and autonomous supply system according to the traction operation and availability of external power, wherein the at least one traction system, and the at least one storage and autonomous electric power supply system are spaced apart in separate vehicles connected by a standard electrical train bus bar (ETBB), and wherein at least part of the electrical power required for traction or (re) charging is distributed through the standard electrical train supply line.

The vehicles according to the present invention comprise an autonomous power supply system on board. The entire system thus comprises an all-electric power train, i.e. an electrically powered traction and propulsion system, such as e.g. an electric motor connected directly, or through gearing to the traction wheels of the vehicle in such manner as to propel the vehicle on the rail tracks.

In a second aspect, the present invention also relates to a method of operating a vehicle according to the invention in an external power mode or an autonomous power-supply mode, depending on the presence or absence of an external power source infrastructure along the trajectory of the vehicle.

According to a third aspect according to the present invention, the present invention relates to a method for converting an vehicle assembly, or a train comprising an electric rail vehicle or a diesel-electric vehicle to an all-electric train capable of moving on railway partially electrified tracks, comprising providing the vehicle a storage and autonomous supply electric power system comprising
a. an accumulator unit comprising one or more electricity accumulators, and
b. a super capacitor unit comprising one or more super-capacitive assemblies;
c. a power supply device for supplying external power when available to the traction and the storage and supply system, and
an intelligent control and distribution system (IEMS) for distributing electric power between the traction system, the power supply device and the electric power storage and autonomous supply system according to the traction operation and availability of external power, wherein the at least one traction system, and the at least one storage and autonomous electric power supply system are spaced apart in separate vehicles connected by a standard electrical train bus bar (ETBB), and wherein at least part of the electrical power required for traction or (re) charging is distributed through the standard electrical train supply line.

### BRIEF DESCRIPTION OF THE DRAWINGS

These and other aspects of the present invention will now be described, by way of example only, with reference to the accompanying drawings, in which:

FIG. 1 is a view of an electrical power system according to a first example, including a schematic overview circuit diagram; wherein Energy Transfer from On-board Energy System (1) and Energy Transfer from train line electricity net, e.g. a catenary is received (2) are show, as well as auxiliary electricity with variable Frequency (3) auxiliary electricity at 50 Hz (4) and energy provision for traction (5),

FIG. 2 is a view of an electrical power system according to a first example, including a schematic overview circuit diagram;

FIG. 3 is an overhead plan view of an auxiliary electrical power system layout of an electrified locomotive according to the first example;

FIG. 4 is an overhead plan showing a possible arrangement of containers on a train;

FIG. 5 is an overhead plan view showing a possible positioning of wagons and power and control units in long-haul and autonomous mode.

“Partially electrified railway tracks” herein refers to railway tracks comprising track sections equipped with external power supply infrastructure, and track sections not equipped with external power supply infrastructure. Typically, railway electrification systems supply electric power to railway vehicles such as locomotives, trains and trams and without an on-board energy supply. Power is typically supplied to trains with a continuous conductor running along the track that usually takes one of two forms, namely an overhead line that is suspended from poles or structures along or atop the rail track; or from a third rail mounted at track level and contacted by a sliding ‘pick-up shoe’. Both overhead wire and third-rail systems usually use the running rails as the return conductor, with the exception of some systems using a separate, fourth rail for this purpose.

When running on the external power supply, the vehicle receives the electrical current needed to run the electrically powered traction and propulsion system by way of a power supply system, including a connector such as e.g. a pantograph carried by the vehicle.

Preferably, the connector is retractable, and may be automatically connected when power and lines are available. Preferably, the connection of the pantograph to the overhead line or third rail is detected in order to best manage switching from one power supply mode to the other, and thus to optimize the performance of the system power. Moreover, in order to optimize the performance of the vehicle, it is necessary that the vehicle is continuously supplied with electrical energy by either the autonomous power supply system, or the external power source, e.g. the catenary, which leads to having transitions during which the vehicle is at both connected to the stand-alone power supply and to the catenary.

During these transitions, the autonomous power supply device may be active, i.e. supplying energy, with an output voltage matching the catenary voltage, thereby avoiding a loss of energy from the autonomous power supply device to the catenary.

The invention also provides for method for controlling the electrical power supply of an all-electrically-powered vehicle operating in stand-alone power supply mode or in external power supply mode, the detection of the connection of the vehicle to an external power supply infrastructure, and may advantageously optimize the management of the transition between the two power supply modes, while being simple and economical.

According to a preferred embodiment of the method according to the invention, when the vehicle is in a transient supply phase during which the power supply unit is simultaneously powered by the autonomous power supply system and connected to the power supply infrastructure, the output voltage of the autonomous power supply system is controlled so that the current passing through the external power supply line is substantially zero, thereby avoiding flow of energy from the autonomous power unit to the grid.

According to another preferred embodiment of the method according to the invention, when during circulation on the rail network the vehicle is powered by the autonomous power supply system and reaches an area equipped with an external power supply, the following steps are carried out:

detection of the presence of an external supply infrastructure for connection with the connecting member, visually by the train chauffeur, or automatically by an indication signal given by e.g. the train safety system, or another automatic means; externally connecting the connection member with the external supply infrastructure, controlling the output voltage of the autonomous power supply system so as to substantially cancel the current to the external power supply line; and stopping the supply of power from the autonomous power supply unit to the power supply unit for traction, and optionally auxiliary energy.

According to yet another characteristic of the method according to the invention, when the vehicle is circulated by being supplied by the external supply line only and reaches an area not equipped with an external supply infrastructure, the disconnection of the connecting member with the external power supply infrastructure in the following steps: switching on the autonomous power supply system in such a way that the latter supplies energy to the power supply unit; controlling the output voltage of the autonomous power supply system so as to substantially match the current of the external power supply line.

The present invention also relates to a modular use of the vehicle, whereby units are present in one or more different sub-units, such as a traction and/or power unit and a traction and control unit.

Ideally, such subunits may be coupled automatically, coupling at the centre of the train in order to separate the traction parts quickly and without the need for personnel.

In addition, a standard electrical train bus bar (ETBB) is provided for electricity supply for the respective control car as well as the individual wagons.

By this power supply to wagons, it is possible to install electrically operated brakes as well as to have power supply for refrigerated containers available. With this conversion, a diesel engine becomes an economical and environmentally-friendly traction variant for both route operation and shunting and connection operation.

Likewise, in this “diesel replacement” operation, an electric regenerative brake is implemented via the feedback into the supercapacitors and accumulator. Excess energy may be stored, or may be used for the production of pressurized air.

Preferably, the accumulators or supercapacitors are charged via the current collector/conductor wire on electrified lines or sections of the track. The accumulator and supercapacitors can be charged under the driving wire during normal operation, whereby. A choice can be made between gentle normal load and full charge. However, since the charging process may have a negative effect on the accumulator life, and intelligent energy management system(IEMS) capable of automatically selecting between the different charging variants due to the journey data, which results in an optimization of the charging status and lifetime.

The IEMS not only optimizes the load of the accumulators alone, but also optimizes starting traction, acceleration and energy consumption during the journey due to the available stretch data.

Thanks to their mechanical design, previous generations of diesel-electric locomotives are ideal for the conversion to CO2-free E-hybrid vehicles, which combine the advantages of a diesel and an electric vehicle. To be able to use the vehicles in both an environmentally friendly and commercially viable mode, it is necessary to modernize or rebuild the existing vehicles. In order to cover the original task area of the diesel engines, an alternative energy source is installed in the form of an accumulator—supercapacitor combination. The supercapacitor element provides the energy peak required for propulsion start-up, whereby the accumulator element supplies the necessary energy of persistence.

Preferably, an electric regenerative brake is implemented via the feedback into the supercapacitor element and accumulator element, whereby excess energy may be stored, or used for the production of pressurized air.

The accumulator element and/or supercapacitor element are charged via the current collector/conductor wire on electrified lines or sections of the track, and may be charged under the driving wire during normal operation.

The continuous charging and discharging process has a negative effect on the accumulator life. An intelligent energy management system (IEMS) is capable of automatically selecting between the different charging variants due to the stretch data, which of course implies an optimization of the charging status and lifetime.

The IEMS not only optimizes the load of the accumulators alone, but also optimizes starting traction, acceleration and energy consumption during the journey due to the available stretch data.

The accumulator assembly preferably comprises accumulator modules selected from lead-acid batteries, lead-carbon batteries, lithium-titanate batteries, zinc-bromine batteries, nickel-zinc batteries, nickel metal hydride (NiMH) batteries, lithium-ion (Li-ion) batteries, lithium polymer (Li-poly) batteries, lithium sulfur (Li—S) batteries, preferably, Lithium-iron-phosphate (Li—FePo4), polymer electrolyte or solid state batteries, due to the comparatively low fire risk at high energy density. Other rechargeable batteries include sodium ion batteries, magnesium ion batteries, and combinations thereof.

The capacitor assembly may be provided as any suitable capacitor adapted for storing the surplus electrical energy of the rail transportation system. Capacitors have long been known and used in electronic circuitry for the storage of electrical energy. In its simplest form, the capacitor includes a pair of electrically conductive plates, typically constructed of metal, separated by air or a dielectric material. The size or area of the conductive plates as well as the permittivity and thickness of the dielectric material between the plates determines the magnitude of the capacitance of the capacitor. Super-capacitor electrodes include a conductive plate, known as a current collector, which is coated with a carbon derivative material, such as activated carbon or graphene. These electrodes are typically separated from each other by an intervening separator made from a porous insulating material that prevents the electrical shorting of the electrodes but allows electrolyte ions to move between the electrodes. In use, when subjected to a voltage, ion flow between the electrodes results in energy storage within the electrodes through the charge separation at the electrode surface with positive charges in one electrode attracting negative ions to that electrode's surface and with negative charges in the other electrode attracting positive ions to that electrode's surface.

By removing the combustion engine and the generator/gearbox, it was found that space is created for installing the components required for the E-hybrid operation in the traction vehicle.

The vehicle assembly may be part of a freight or of a passenger train, or of mixed configuration trains. The electrical power system may comprise at least one electrical power supply unit for providing electrical power, both primary and auxiliary, to a wagon or train car, or multiple wagons or train cars.

The electrical power supply unit may provide electrical power to a plurality of wagons. The electrical power supply unit may provide an electrical power output. The electrical power output may be for providing primary, i.e. for the propulsion and for charging of the autonomous power supply devices, or auxiliary electrical power, e.g. for refrigeration, heating or light, to a plurality of wagons or train cars. Preferred is a single electrical power output providing electrical power for the plurality of wagons or train cars.

The primary, and the auxiliary electrical system may comprise a power supply unit that is powered by electricity that is drawn from a rail power line, such as drawn from a catenary or overhead line. The electrical system's power supply unit may comprise a convertor. Preferably, the electrical system may comprise a convertor for converting electricity from a standard electrical train bus bar ETBB (“Zugsammelschiene”, also known as Electric Train Supply line, ETS), which allows to connect the power supply units by standardised plug and socket connections. The train bus bar may be for providing the train with operational power, such as for the locomotion of the train. The train bus bar may provide traction and/or braking power/s for the train. The train bus bar may comprise a standard electrical train bus bar for supplying power along the train, such as with connections between wagons of the train. The power output may provide an additional or alternative power output to a train's bus bar. For example, the power output may provide an additional power output, such as with a different power and/or voltage and/or current rating to the train's bus bar.

The power system comprises an entirely electrical power system. In contrast to a power system whereby electricity may be indirectly generated, such as via a generator (e.g. diesel or associated with locomotion, such as a dynamo), an entirely electrical power system may be advantageous. Preferably, the electrical power system may power the vehicle or train independently of movement of the railway vehicle, such as when the railway vehicle is, or has been, stationary. The electrical power system according to the invention is operational without generation such as without a dynamo; and/or without a generator, and hence may not provide or demand any extra resistance or friction on the train wheel.

The electrical power from and to the power supply unit in the vehicle assembly may be supplied through the standard electrical train bus bar, or through a separate, discrete electrical power network. Preferably, the standard electrical train bus bar is employed, Applicants found that the standard electrical train bus bar (ETBB or Zugsammelschiene) has a sufficiently large capacity, as it permits currents of up to 3.000 Volt and 800 Ampere, which suffices for transmitting power for traction and charging/recharging operations provided that the power is managed in a manner not to damage the train bus bar.

This approach thus permits provision of traction, even if the power supply module is in a separate wagon, e.g. in the form of a standardized container that is tendered after, or pushed by a locomotive, to which it is connected by the ETBB.

In an alternative embodiment, the power supply modules and a traction unit are based in a power supply tender, and are controlled and connected to a separate traction module, e.g. an all-electric or diesel-hydraulic locomotive that forms the traction unit.

The benefit of using a modular power supply unit without traction permits the use of normal, standard e-locomotives in combination with a power supply container, thereby effectively converting a standard vehicle assembly, in particular if without autonomous energy supply and hence bound to line-sourced power, to an all-electric hybrid assembly.

Preferably, and where required, a change to the electric locomotive set up may be made. Usually, when a pantograph is down, the main switch of the locomotive is automatically set to “OFF”, to avoid a currents or voltage to apply to the catenary, and the rood of the locomotive. The control software in the electric locomotive must therefore be informed of the autonomous battery electrical operation without catenary.

Alternatively, an auxiliary switch may be installed that accepts the train bus as the second external power source. This ensures that the pantograph is not activated, the main switch remains off, and hence there is no voltage on the roof of the locomotive. The DC intermediate circuit is then fed via the ETBB (Zugsammelschiene) to maintain operability.

Alternatively, a diesel-electric vehicle assembly can be converted to an all-electric assembly by disabling, or preferably dismantling the diesel engine/generator unit, and using the autonomous power supply from the power supply modules. Also, one or more combined power and traction unit may be easily added to a train, and controlled preferably remotely from a locomotive. In this manner, an existing diesel-driven train, or trains that require external electric power may be converted to an all-electric and autonomous train, e.g. for shunting or otherwise operations. Beneficially, the containers may be used to harness and store other forms of, preferably renewable energy, such as wind and solar power, and be coupled ready-charged to a standard train, to make it independent from external power grid.

The electrical power output may comprise 3-phase AC. The electrical power output may comprise a voltage in a range of about 100V to about 3000V. The electrical power output may supply a voltage in a range of about 300V to about 1500V, however preferably supplies a voltage that is stable within a narrow range, e.g. of from 950 to 1050V for increased stability of accumulator and supercapacitor.

In at least some examples, the convertor is configured to supply an electrical power output of about 360V to about 460V, at about 50 HZ. In at least some examples, the convertor is configured to supply an electrical power output of about 400V to about 500V, 60 HZ. In at least one example, the electrical power output is about 400V, 50 Hz.

The present power supply system may advantageously also provide auxiliary power, for e.g. for use of a refrigeration system; an air-conditioning system; a heating system; a circulation system, such as incorporating a fan and/or a vent. The auxiliary electrical system may be for supplying the output power to a plurality of appliances.

The power output may comprise an AC voltage/s. The power output may provide an electrical power supply suitable for an electrical goods-related system, without requiring further or additional adaptation to be fed in or connected to the goods-related system. In at least some examples, the electrical power output may be configured for or suitable for direct connection to a goods container, such as a reefer.

The power supply unit may comprise a convertor. The convertor may comprise a transformer. The convertor may convert an AC voltage into an AC voltage. Additionally or alternatively, the convertor may convert a DC voltage into an AC voltage. Additionally or alternatively, the convertor may convert an AC voltage into a DC voltage. Additionally, or alternatively, the convertor may convert a DC voltage into a DC voltage. The convertor may provide a voltage step-down.

The control unit may comprise an accumulator and supercapacitors management system monitoring and equalizing the accumulators and/or supercapacitors to maintain a desired state of charge and depth of discharge for each accumulator. A motor control circuitry may operate in coordination with the accumulator management system to draw currents from the accumulator assembly to drive the plurality of traction motors according to desired throttle levels. The accumulator management system may further monitor the accumulator assembly with temperature sensors and may cause cooling or air-circulation equipment to equalize accumulator temperatures. A brake system may comprise both a regenerative braking mechanism and an air braking mechanism wherein the former is prioritized over the latter so that brake energy can be recovered to recharge the accumulator assembly.

In another particular exemplary embodiment, two or more accumulator-powered, all-electric locomotives may be coupled together and operate in tandem.

In yet another embodiment, one or more accumulator-powered locomotives may be coupled with one or more other types of locomotives such as diesel-electric locomotives. An accumulator assembly carried on the accumulator-powered or accumulator-carrying locomotive(s) may be recharged with energy generated from regenerative braking and/or from engine(s) on the diesel-electric locomotive(s). The accumulator assembly may also supply electric power to drive traction motors on the accumulator-powered locomotive(s) and/or the diesel-electric locomotive(s).

According to a further aspect, there is provided a railway vehicle, such as a train, comprising at least one vehicle of any other aspect, example, embodiment or claim and at least one different railway vehicle of any other aspect, example, embodiment or claim.

The train may comprise a single vehicle, such as in rail busses, or multiple wagons. The train thus formed may be configured to move up to one or more of: 10 wagons; 15 wagons; 20 wagons; 25 wagons; 30 wagons; 35 wagons, or 40 wagons. In at least some examples, a single locomotive may be configured to provide the motion of more than 25 wagons. The train may comprise a plurality of power supply units. Accordingly, in at least some example trains, two or more locomotives or drive train vehicles may provide motion, to 50 or more wagons.

According to a further aspect there is provided a method of powering a railway-based propulsion system, such as powering a freight train. The method may comprise supplying auxiliary electrical power to a goods-related electrical system.

The method may comprise monitoring a status. The status may comprise an electrical status of a locomotive. For example, the method may comprise checking electrical supply connection.

The method may comprise sending a signal when or whenever the propulsion mode is changed, using the data for the presence or absence of infrastructure as available in the train safety system. For example, the power supply unit may be controlled or managed by a controller that identifies energy use for the locomotive. The method may also providing tracking capabilities to verify the amount of energy consumed by the locomotive, and preferably certify this use, e.g. using a certification system, that certifies the use of energy per locomotive, or per train. An example for such certification is the use of a block chain method encrypting and certifying an attached energy use file.

The method may comprise performing one or more actions in response to electrical (dis)connecting, such as one or more of: sending a signal, measuring the amount of electrical current, and recharging the accumulator and the supercapacitor units, a queuing the container in a power management system.

The action or actions may be predetermined, and/or automated. Additionally, or alternatively the actions may be selectable and/or manual. Sending the signal may comprise sending the signal within the train. Additionally, or alternatively, sending the signal may comprise sending the signal remotely from the train, such as remotely to a control or logging centre (e.g. at a fixed location, such as via satellite or telecommunication link).

During operation, when the vehicle is about to leave a zone equipped e.g. with a catenary to enter a zone that is not such equipped, the autonomous power supply system is switched back to active mode either on command of the driver or automatically, for example by interaction with a beacon arranged along the track or else by estimation of the position by a computer or via train safety management systems. During this phase, the power supply system is briefly simultaneously powered by the autonomous power supply system and the external power supply line. At this point in time, the control unit then regulates the output voltage of the autonomous power supply system as to match essentially the current in the external power supply line, and thus avoids a discharge of the autonomous power supply system to the catenary.

The method further comprise locally collecting, buffering and/or storing electrical power, such on or at a container that can be conveniently be tendered in a train, further referred to as Container Power Pack (CPP). This may allow to add fully charged power supply modules in separate Container Power Packs carried on a standard chassis, and take off discharged Container Power Packs by simply coupling or uncoupling the tender onto or from the train.

For example, between a vehicle assembly and the following wagons, a CPP may be provided as an additional accumulator for a discontinuity in electrical supply from the train line. For example, this local buffer may enable a train o vehicle assembly to perform one or more actions when disconnected or upon disconnection, such as to send signal indicative of disconnection or prolonged disconnection, to move or continue traction.

Another aspect of the present disclosure provides a computer program comprising instructions arranged, when executed, to implement a method in accordance with any other aspect, example or embodiment. A further aspect provides machine-readable storage storing such a program.

The invention includes one or more corresponding aspects, embodiments or features in isolation or in various combinations whether or not specifically stated (including claimed) in that combination or in isolation. For example, it will readily be appreciated that features recited as optional with respect to the first aspect may be additionally applicable with respect to the other aspects without the need to explicitly and unnecessarily list those various combinations and permutations here (e.g. the device of one aspect may comprise features of any other aspect). Optional features as recited in respect of a method may be additionally applicable to an apparatus or device; and vice versa.

In addition, corresponding means for performing one or more of the discussed functions are also within the present disclosure.

It will be appreciated that one or more embodiments/aspects may be useful in at least partially powering a railway-associated system. The above summary is intended to be merely exemplary and non-limiting.

Various respective aspects and features of the present disclosure are defined in the appended claims.

It may be an aim of certain embodiments of the present disclosure to solve, mitigate or obviate, at least partly, at least one of the problems and/or disadvantages associated with the prior art. Certain embodiments or examples may aim to provide at least one of the advantages described herein.

### DETAILED DESCRIPTION

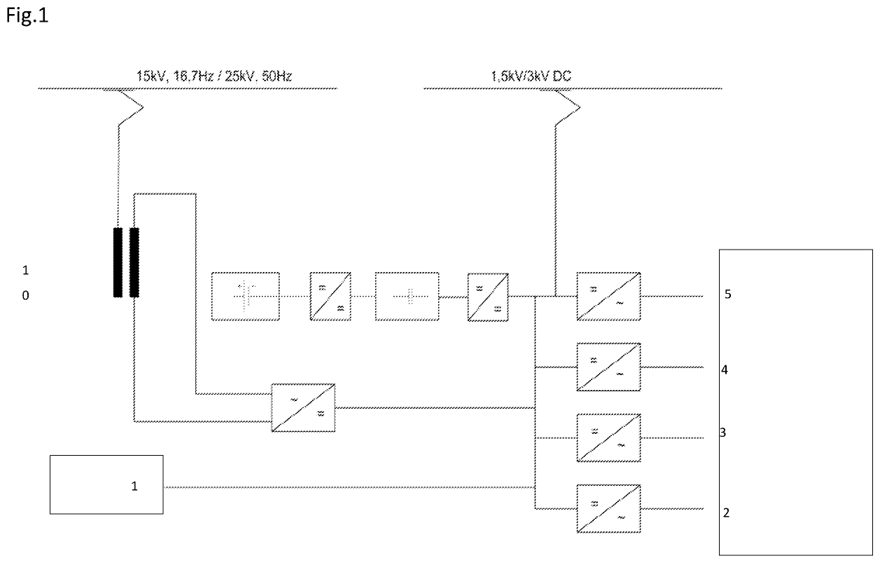

Referring initially to FIG. 1, there is shown an electrical power system, generally referenced by numeral 10, according to a first example. According to a first aspect there is provided an electrical power system for a railway or railroad vehicle. FIG. 1 is a view of an electrical power system including a schematic overview circuit diagram; showing the energy transfer from the on-board autonomous energy system (1) and from the external source, such as train line electricity net, e.g. via a catenary (2), as well as provision of auxiliary electricity with variable frequency (3) auxiliary electricity at 50 Hz (4) and energy provision for traction (5)

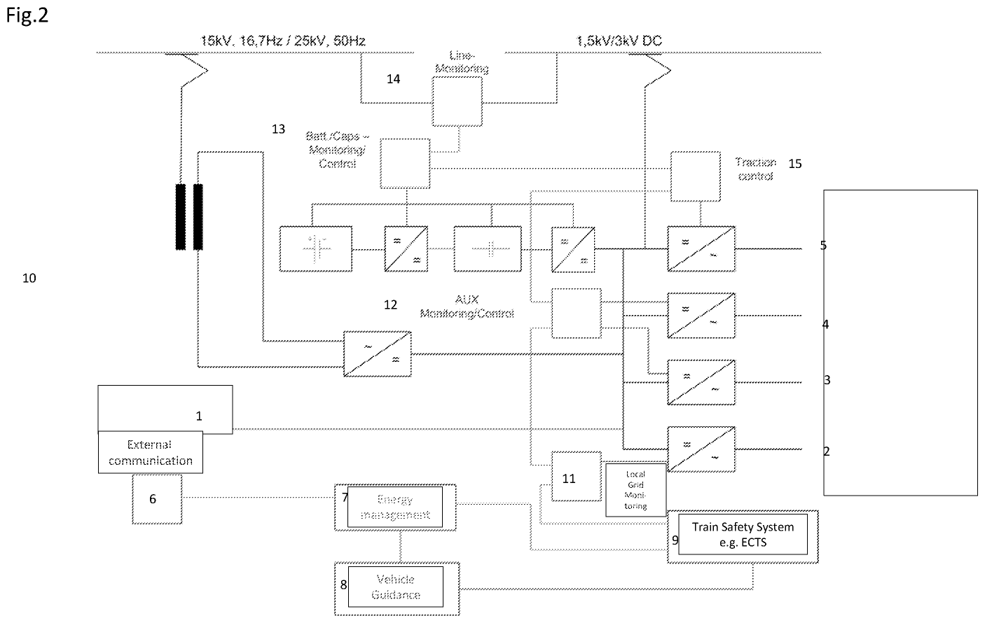

FIG. 2 shows the system depicted in FIG. 1, but with the control system depicted as well. Numerals 1 to 5 are as in FIG. 1; the system further has an external communication unit (6), energy management system (7), vehicle control (8), train safety system (8), such as e.g. ETCS; local electricity net monitoring unit (11); auxiliary power monitoring and control unit (12), accumulator and supercapacitor monitoring and control unit (13), line monitoring and control unit (14), and traction control (15).

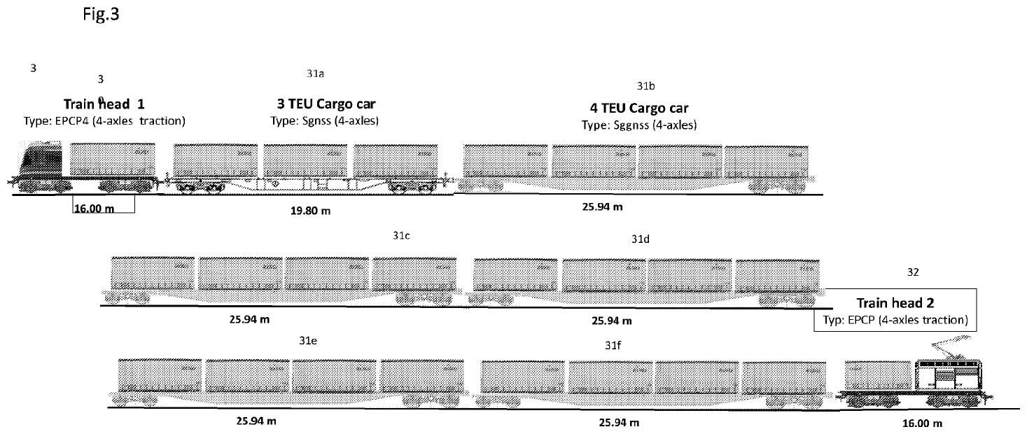

FIG. 3 shows an exemplary freight train combination according to the subject invention, Herein, train 10 comprises a freight train, whereby power modules are based in the middle of the train, whereas control, or combined control traction units with cabin are based at each end of the train.

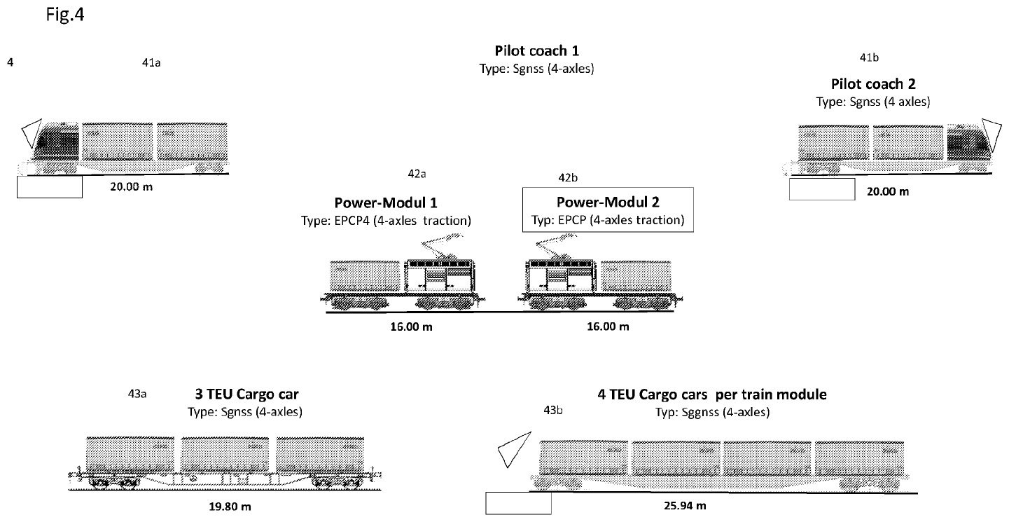

FIG. 4 shows a modular construction of a freight train combination according to the subject invention, Herein, train 40 comprises power modules (40a, 40b) that may be based in the middle of the train, whereas control, or combined control traction units with cabin (41a, 41b) are based at each end of the train, and wagons (43a, 43b) maybe arranged in various combinations between the traction and power units; for maritime hinterland transports (i.e. combining ship and train transport in the way of so called multimodal transport chains), a set up with 5 shortened 80′ wagons and one 60′ wagon per module is found particularly useful, as it permits main line operations on the areas with catenary wire, which permits performance sufficient for operating speed 140 km/h, while shunting operations at railway sidings without catenary wire are possible via accumulator modules with speeds e.g. up to 25 km/h, or up to 80 or even 100 km/h on certain parts of the rail network where higher speed traffic is required. For shunting operations, a limit of typically 25 km/h may be applied due to certain regulations that shunting speed cannot exceed certain limits. It should be noted that any kind or type of wagons may be employed in trains according o the present invention.

Due to the centrally located traction units, for “Push-Pull” operations, control or combined control traction units equipped with a small propulsion unit as well as small driver cab for train control during long distance as well as shunting operations may be advantageously be employed.

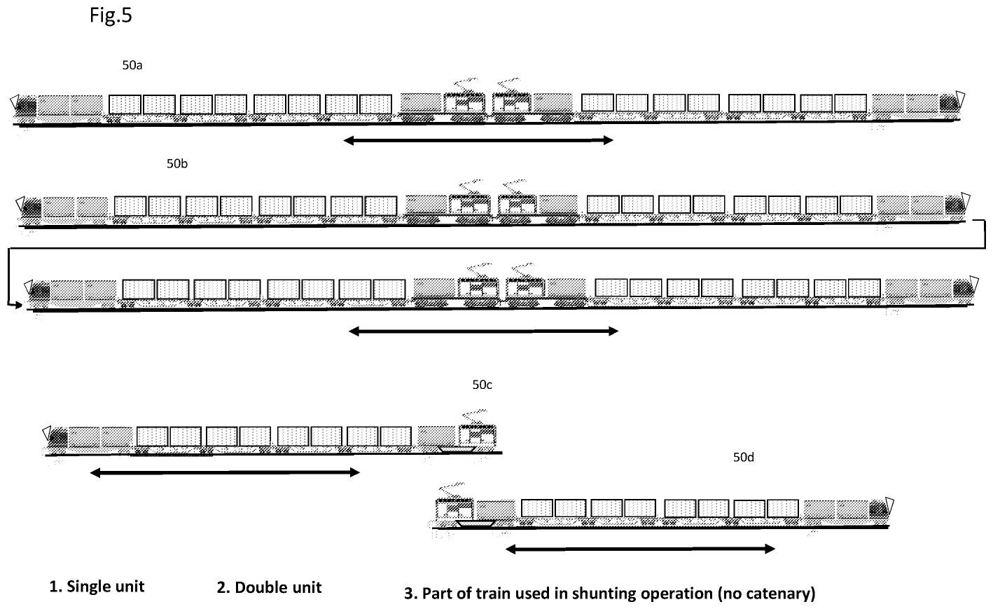

FIG. 5 illustrates that preferably in this modular deployment, long-haul train units run on catenary electricity for the longer distances may advantageously be separated into two or more train segments via automated coupling/uncoupling between the power modules. Accordingly, this permits multiple unit operations with two or more train units on long-haul operations, while the flexible train units can be decoupled and can be coupled for shunting and maneuvering, eliminating additional shunting maneuvers with separate e.g. diesel locomotives, which is cost advantageous due to the low maintenance/higher up time and lower energy consumption, Since this is also achieving a zero emission, this is automatically guaranteed, and removes the need for separately accounting, but can be automatically incorporated into CO₂ avoidance schemes, as will be set out below. Single unit (50a), double unit (50b); Part of a train used in shunting operation (no catenary, 50c).

The present vehicle and its power system comprise an entirely electrical power system. In contrast to a power system whereby electricity is indirectly generated, such as via a generator, for instance a wheel dynamo, an entirely electrical power system is advantageous.

For example, the autonomous power supply system can power not only the locomotive, but also provide auxiliary power to the plurality of wagons independently of movement of the train, such as when the train is, or has been, stationary; or is moving slowly.

The auxiliary electrical power system is then operational independently if the train is connected to a railway powerline, or not. Also, preferably, the auxiliary electrical power system can thus be operated without generation, thus not needing a dynamo or a separate diesel or otherwise generator. Also, for the auxiliary electrical power, no additional accumulator providing electrical power directly to the wagons is required, reducing both costs and complexity.

Particularly compared to a generator-based system, the present electrical autonomous power system comprises a minimum of, or no parts subject to wear.

Preferably, the auxiliary electrical power is provided from the autonomous power system through standard cable connections between wagons, and thus does not provide or demand any extra resistance on wheels of the train; and is generally insensitive to weather and train speed.

The locomotive comprises standard electrical train bus bar (Zugsammelschiene) for connection to wagons, preferably using standards presently in use.

It will be appreciated that any of the aforementioned apparatus may have other functions in addition to the mentioned functions, and that these functions is performed by the same apparatus.

A further aspect of the present invention also relates to a Container Power Pack configured to, and operable for coupling to a train or locomotive as power source, the container power pack comprising a. a storage and autonomous electric power supply system comprising i. an accumulator unit comprising one or more electricity accumulators, and ii. a super capacitor unit comprising one or more super-capacitive assemblies; and, optionally, b. a control and distribution system for distributing electric power to the traction system. Such Containers, whether on a bogie, or to be placed on a bogie, may be provided at useful positions, to provide auxiliary power, and may be charged off-line. In this way, a vehicle assembly may be provided with autonomous power by a simple addition or swap of the accumulator module.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims.

The applicant indicates that aspects of the present invention may consist of any such individual feature or combination of features. It should be understood that the embodiments described herein are merely exemplary and that various modifications is made thereto without departing from the scope or spirit of the invention. For example, it will be appreciated that although shown here as a single-mother arrangement, other systems may have multiple mothers (e.g. multiple mothers, within/along a single train, each mother supplying one or more daughter wagons).

1. An electrically-powered vehicle assembly for moving on partially electrified railway tracks, the vehicle assembly comprising: an electrically powered traction system;
a. a storage and autonomous electric power supply system comprising
i. an accumulator unit comprising one or more electricity accumulators, and
ii. a super capacitor unit comprising one or more super-capacitive assemblies;
b. a power supply device for supplying external power when available to the traction and the storage and supply system, and
c. a control and distribution system for distributing electric power between the traction system, the power supply device and the electric power storage and autonomous supply system according to the traction operation and availability of external power;
wherein the at least one traction system, and the at least one storage and autonomous electric power supply system are spaced apart in separate vehicles connected by a standard electrical train bus bar (ETBB), and wherein at least part of the electrical power required for traction or (re) charging is distributed through the standard electrical train supply line.

2. A vehicle assembly according to claim 1, wherein the vehicle is adapted to operate in a stand-alone mode or in an external power supply mode, depending on whether or not an external power supply is available along the rail track of the vehicle.

3. A vehicle assembly according to claim 1, wherein component (a) to (c) and the traction unit combined in one vehicle, to form a combined power supply and traction unit, wherein this unit is preferably managed remotely from a locomotive or a from a different location in the vehicle assembly.

4. A vehicle assembly according to claim 1, wherein the at least one traction system, and the at least one storage and autonomous electric power supply system are spaced apart in separate vehicles connected by a standard electrical train bus bar (ETBB), and wherein at least part of the electrical power required for traction or (re) charging is distributed through the standard electrical train supply line.

5. A vehicle assembly according to claim 1, wherein the super-capacitive assemblies comprise a plurality of supercapacitors connected in series and/or in parallel, with a combined capacity sufficient to power the traction device for an initial operational phase on autonomous power supply, and/or when the operational mode is switched between autonomous and external power supply.

6. A vehicle assembly according to claim 1, wherein the power supply device comprises at least one retractable connection member, preferably a catenary collection device, more preferably a least one pantograph, for collecting power from a catenary power line.

7. A vehicle assembly according to claim 1, wherein the control and distribution system is adapted to provide and to control recharging of the accumulators and/or super-capacitive assemblies by at least part of the external power available during externally powered operation.

8. A vehicle assembly according to claim 1, wherein the control and distribution system is adapted to control re- and discharging of the accumulator assembly and the one or more super- capacitive assemblies with the available power not used for traction of the vehicle.

9. A vehicle assembly according to claim 1, wherein the power supply unit is adapted to be connected to both the power supply and storage system on board of the vehicle, and the power supply means connectable to an external power supply structure by means of a retractable connection member; the power supply system further adapted to actively and automatically control the connection of the connection member by a logic to retract the connection member in absence of an external power supply structure, or in absence of a current in the external power supply infrastructure, and logic to extend the connection member in the presence of an external power supply infrastructure, and/or the presence of a current in the external power supply infrastructure, to connect to the power supply.

10. A vehicle assembly according to claim 1 for being connected to an external power supply infrastructure by means of a connection member, comprising a current sensor for measuring the current flowing through in order to detect the connection of the connecting member to the external supply infrastructure.

11. A vehicle assembly according to claim 1, wherein the control and distribution system is adapted to balance power surges provided by the external catenary and power drainage peaks in the power supply system or by the traction system through use of the supercapacitor unit, preferably also during regenerative power peaks feeding back into the power supply system.

12. A vehicle assembly according to claim 1, wherein the power supply device is adapted to maintain dynamic traction performance of the vehicle during transition between operating phases, wherein the vehicle is switching power provision between the available external and internal sources..

13. A vehicle assembly according to claim 1, wherein the control module is provided for modifying the output voltage of the system power supply unit.

14. A vehicle assembly according to claim 1, wherein the connecting member consists of a pantograph carried by the vehicle and adapted for cooperating with a catenary as external power supply.

15. A vehicle assembly according to claim 1, wherein the control unit and the autonomous power system are adapted to match the supplied voltage to the energy storage module according to the state of charge of the storage module of energy, in which the power supply unit and the control unit are adapted to cooperate during a power transfer by the external power source to the on-board energy storage system.

16. A vehicle assembly according to claim 1, wherein the control unit comprises a sensor and logic to monitor the state of the energy storage module, and to control the operation of the energy converter according to the monitored state, to optimize useful accumulator lifetime.

17. A train comprising one or more vehicle assemblies according to claim 1, and a plurality of wagons.

18. A method of operating a vehicle assembly according to claim 1 in an external power mode or an autonomous power-supply mode, depending on the presence or absence of an external power source infrastructure along the trajectory of the vehicle.

19. A method according to claim 18, wherein the vehicle assembly comprises a power supply system connected to both the power supply and storage system on board of the vehicle and the power supply system connectable to the external power supply structure by means of a retractable connection member, wherein the connection of the connection member is controlled by measuring the current flowing through the external power supply line, wherein the presence of a current in the external power supply structure signals the presence of an external power supply infrastructure when connected by the retractable connection member.

20. A method according to claim 19, wherein when the vehicle assembly is in a transient supply phase during which the power supply system is simultaneously supplied with power from the on-board power supply and connected to the external power supply infrastructure, the output voltage of the autonomous power supply system is controlled in such a way that the current flowing through the power line is essentially zero.

21.-27. (canceled)
